(19) United States
(12) Patent Application Publication
(10) Pub. No.: US 2009/0310090 A1
(43) Pub. Date: Dec. 17, 2009

(54) COLOR WHEEL AND PROJECTOR HAVING SAME

(75) Inventors: YU-LUN HO, Tu-Cheng (TW); PO-WEN CHAN, Tu-Cheng (TW); JUIN-HONG LIN, Tu-Cheng (TW); I-PEN CHIEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/200,862

(22) Filed: Aug. 28, 2008

(30) Foreign Application Priority Data
Jun. 13, 2008 (CN) 200810302145.1

(51) Int. Cl. G02B 5/22; G03B 21/14

(52) U.S. Cl. 353/84; 359/361; 359/891

(57) ABSTRACT

A color wheel includes a motor, a carrier, a number of color filter segments, a layer of adhesive, and an ultraviolet (UV) filter. The motor includes a rotor. The carrier is fixed to the rotor. The color filter segments are adhesively attached to the carrier. The ultraviolet filter is placed so that the adhesive is interposed between the UV filter and the carrier. The ultraviolet filter is substantially similar to the color filter segments in shape and size.

### BACKGROUND

1. Technical Field

The invention relates to color wheels and, particularly, to a color wheel combining color filter segments adhesively thereof and a projector having the same.

2. Description of the Related Art

A color wheel for use in projectors typically includes a carrier and color filter segments. The color filter segments are combined on the carrier adhesively. Color wheels typically include a cover attached to the combined color filter segments configured for blocking light from directly impinging on the adhesive. On the other hand, the diameter of the cover is significantly smaller than that of the color filter segments to leave a light transmissive region on the combined color filter segments for filtering light. As a consequence, a small amount of light can still reach the adhesive via reflections in the combined color filter segments, thereby deteriorating the adhesive.

Therefore, it is desirable to provide a color wheel and a projector that can overcome the above-mentioned problem.

### SUMMARY

In an exemplary embodiment, a color wheel includes a motor, a carrier, a number of color filter segments, a layer of adhesive, and an ultraviolet (UV) filter. The motor includes a rotor. The carrier is fixed to the rotor. The color filter segments are adhesively attached to the carrier. The ultraviolet filter is placed so that the adhesive is interposed between the UV filter and the carrier. The ultraviolet filter is substantially similar to the color filter segments in shape and size.

### BRIEF DESCRIPTION OF THE DRAWINGS

FIG. 1 is schematic, planar view of a projector according to a first embodiment.

FIG. 2 is a schematic, planar view of a color wheel according to a second embodiment.

FIG. 3 is a schematic, planar view of a color wheel according to a third embodiment.

### DETAILED DESCRIPTION OF THE EMBODIMENTS

Embodiments of the present color wheel and projector will now be described in detail with references to the accompanying drawings.

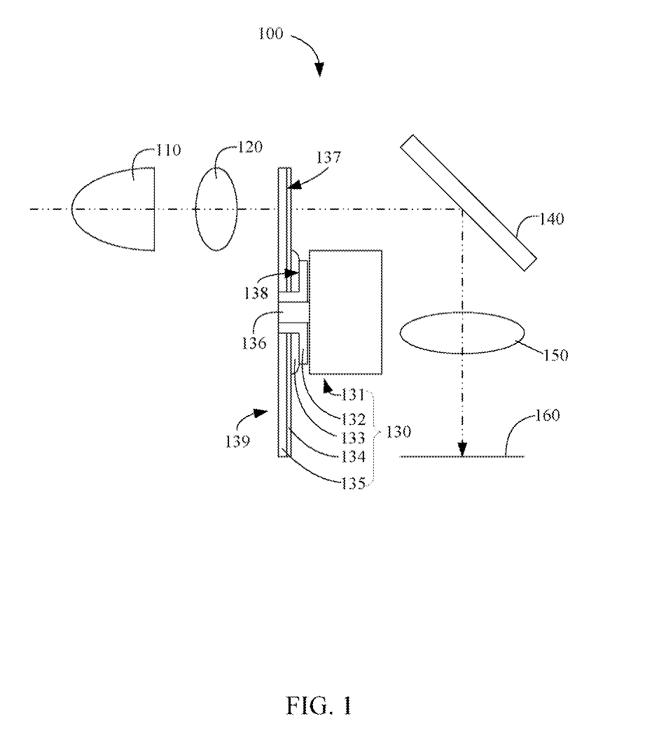

Referring to FIG. 1, a projector 100 such as a digital light processing (DLP) projector, according to a first embodiment, includes a light source 110, a condensing lens 120, a color wheel 130, a digital micro-mirror device (DMD) 140, and a projection lens 150.

The light source 110, such as a high pressure mercury lamp, a metal halide lamp, or a xenon lamp, is configured for generating white light. The condensing lens 120 is configured for condensing the generated white light from the light source 110.

The color wheel 130 is configured for dispersing the condensed white light impinging thereon into three colored lights, such as red (R), green (G), and blue (B) lights. The color wheel 130 includes a motor 131, a carrier 132, a layer of adhesive 133, a number of color filter segments 135, and an ultraviolet filter 134. The motor 131 includes a rotor 136. The carrier 132 is fixed to the rotor 136 via adhesive or threads. The color filter segments 135 are annularly arranged and attached to the carrier 132 via the adhesive 133. In this embodiment, the UV filter 134 is a film formed on a first surface 137 of the arranged color filter segments 135 facing the adhesive 133. Specifically, the carrier 132 is disk-shaped and has an attachable surface 138 facing away from the motor 131. The color filter segments 135 may include three color filter segments 135 such as R, G, and B color filters, and are coaxially attached to the attachable surface 138. Therefore, the color filter segments 135 are combined on the carrier 132 and form an annular transmissive region 139 being inserted in the light path of the condensed white light. When the rotor 136 rotates, the annular transmissive region 139 also rotates and disperses the condensed white light into color lights, e.g., R, G and B lights, in sequence. In this embodiment, the carrier 132 is a metal ring. The adhesive 133 is a hot and curable adhesive, such as UV curable adhesive.

The motor 131 is configured for driving the color filter segments 135 to rotate. In this embodiment, the rotor 136 is a rotating housing with a shaft coaxially protruding therefrom. In addition to the rotor 136, the motor 131 further includes electromagnetic members (not shown), e.g., ferromagnets coated to the inner surface of the rotating housing and windings fixedly received within the rotating housing for driving the rotor 136 to rotate when the windings are electrically powered.

When assembling the color wheel 130, the UV filter 134 is firstly formed on the color filter segments 135 via various deposition methods. Then, adhesive 133 is spread over the attachable surface 138. Next, the color filter segments 135 formed with the UV filter 134 are disposed on the adhesive 133 in an annular manner. Subsequently, the adhesive 133 is cured to fixedly combine the color filter segments 135 on the carrier 132. Finally, the combination of the carrier 132, the color filter segments 135 and the UV filter 134 is fixed to the rotor 136.

The DMD 140 is configured for modulating the color lights from the color wheel 130 into visual images according to input video signals. The projection lens 150 is configured for enlarging the visual images and presenting them on a screen 160.

The UV filter 134 of this embodiment can efficiently prevent light reflected from the color filter segments 135 from impinging the adhesive 133, thereby ensuring the quality and longevity of the adhesive 133.

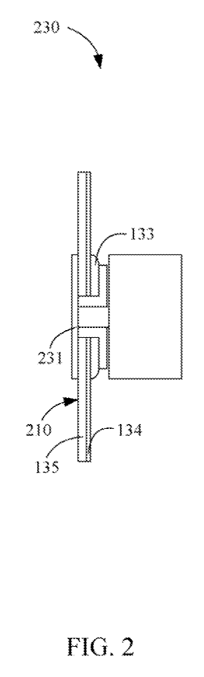

Referring to FIG. 2, a color wheel 230, according to a second embodiment, is essentially similar to the color wheel 130, except having an additional cover 231. The cover 231 is attached to a second surface 210 of the color filter segments 135 facing away from the UV filter 134 and covers the layer of adhesive 133. This cover 231 can block light from the entire spectrum, thereby providing better protection for the adhesive 133.

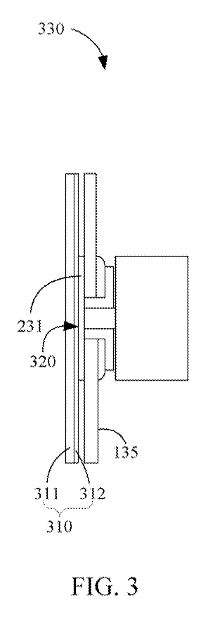

Referring FIG. 3, a color wheel 330, according to a third embodiment, is essentially similar to the color wheel 230 with the exception of the UV filter 310. In this embodiment, the UV filter 310 includes a transparent substrate 311 and a UV filter film 312, and is attached to a surface 320 of the cover 231 facing away from the arranged color filter segments 135. The transparent substrate 311 is essentially similar to the arranged color filter segments 135 in shape and size. The UV filter film 312 is formed on the transparent substrate 311. In this embodiment, the cover can be omitted to reduce costs.

The UV filter is not limited to the described embodiments and can be any UV filter placed so that the adhesive 133 is interposed between the UV filter and the carrier 132 and is similar to the arranged color filter segments 135 in shape and size. For example, the UV filter 134 can be a film formed on the surface 138, or a transparent substrate formed with UV filter film and attached to the surface 137, 138.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A color wheel for use in a projector, comprising:
a motor comprising a rotor;
a carrier fixed to the rotor;
a plurality of color filter segments annularly arranged and adhesively attached to the carrier; and
an ultraviolet filter, similar to the arranged color filter segments in shape and size, adhesively placed on the carrier so that the adhesive is interposed between the ultraviolet filter and the carrier.

2. The color wheel as claimed in claim 1, wherein the carrier is fixed to the rotor via adhesive or threads.

3. The color wheel as claimed in claim 1, wherein the carrier is disk-shaped and comprises an attachable surface facing away from the motor, the arranged color filter segments being coaxially attached to the attachable surface to form an annular transmissive region being inserted in the light path of the projector.

4. The color wheel as claimed in claim 1, wherein the carrier comprises a metal ring.

5. The color wheel as claimed in claim 1, wherein the color filter segments comprises a red color filter, a green color filter and a blue color filter.

6. The color wheel as claimed in claim 1, wherein the adhesive is a hot curable adhesive.

7. The color wheel as claimed in claim 1, wherein the adhesive is an ultraviolet curable adhesive.

8. The color wheel as claimed in claim 1, wherein the ultraviolet filter is a film formed on the arranged color filter segments.

9. The color wheel as claimed in claim 1, wherein the ultraviolet filter comprises a transparent substrate and an ultraviolet filter film formed on the transparent substrate.

10. The color wheel as claimed in claim 1, further comprising a cover for blocking light, the cover being attached to a surface of the arranged color filter segments facing away from and covering the adhesive.

11. A projector comprising:
a light source for generating white light;
a condensing lens for condensing the generated white light;
a color wheel comprising:
a motor comprising a rotor;
a carrier fixed to the rotor;
a plurality of color filter segments annularly arranged and adhesively attached to the carrier to form a transmissive region being inserted in the light path of the condensed white light and rotating to disperse the condensed white light into color lights in sequence; and
an ultraviolet filter adhesively placed so that the adhesive is interposed between the ultraviolet filter and the carrier, the ultraviolet filter being similar to the arranged color filter segments in shape and size.
a digital micro-mirror device configured for modulating the dispersed color lights into visual images; and
a projection lens configured for enlarging the visual images and presenting the enlarged visual images on a screen.

12. The projector as claimed in claim 11, wherein the light source comprises a lamp selected from the group consisting of high pressure mercury, metal halide and xenon.
